(19) United States
(12) Patent Application Publication
(10) Pub. No.: US 2025/0155102 A1
(43) Pub. Date: May 15, 2025

(54) VEHICLE LAMP AND METHOD OF MANUFACTURING CONNECTOR FOR SAME

(71) Applicant: SL Corporation, Daegu (KR)

(72) Inventors: Minsuk KIM, Gyeongsan-si (KR); Yeounghan BAK, Gyeongsan-si (KR); Minkyu HER, Gyeongsan-si (KR)

(21) Appl. No.: 18/947,099

(22) Filed: Nov. 14, 2024

(30) Foreign Application Priority Data
Nov. 14, 2023 (KR) 10-2023-0157324

(51) Int. Cl. F21S 45/60; F21S 41/19; F21S 41/24; F21S 41/47; F21S 43/19; F21S 43/239

(52) U.S. Cl. CPC F21S 45/60; F21S 41/192; F21S 41/24; F21S 41/47; F21S 43/195; F21S 43/239; F21S 2243/00

(57) ABSTRACT

A vehicle lamp includes a film; and a connector having a housing disposed on a first side of the film, a metal plate disposed on a second side of the film, and a terminal coupled to sequentially penetrate through the housing, the film, and the metal plate. An end of the terminal penetrating the metal plate is welded to the metal plate. Additionally, a method of manufacturing a connector for a vehicle lamp includes disposing a housing on a first side of a film; disposing a metal plate on a second side of the film to correspond to the position of the housing; and coupling a terminal such that the terminal sequentially penetrates through the housing, the film, and the metal plate.

### CROSS-REFERENCE TO RELATED APPLICATION

This application claims priority from Korean Patent Application No. 10-2023-0157324 filed on Nov. 14, 2023, which is incorporated herein by reference in its entirety.

### BACKGROUND

### 1. Technical Field

The present disclosure relates to a vehicle lamp and a method of manufacturing a connector for the vehicle lamp, and more particularly, to a vehicle lamp and a method of manufacturing a connector for the vehicle lamp that allow for more secure installation of the connector on a film included in the vehicle lamp.

### 2. Description of the Related Art

Generally, vehicles are equipped with lamps that serve the illumination function for more easily identifying objects around them during low-light conditions (e.g., nighttime driving), and the signaling function for informing other vehicles or road users of their driving status.

For example, vehicle lamps include headlamps that illuminate the front side of the vehicle to secure the driver's view, brake lamps that illuminate when the brakes are applied, turn signal lamps used when making a right or left turn, and reverse lamps that illuminate when reversing. Additionally, reflectors that perform the function of reflecting light to make the vehicle more easily recognizable from the front and rear are also mounted.

At least some of the vehicle lamps include heating wires (equipped for, e.g., defrosting the lamp surface), and there is a difficulty in mounting a connector on the film to supply power to the heating wires. Furthermore, during the manufacturing processes of mounting the connector on the film and injection-molding the vehicle lamp, manufacturing defects such as deformation of the connector may occur, necessitating a technique for improvement.

### SUMMARY

Aspects of the present disclosure provide a vehicle lamp and a method of manufacturing a connector for the vehicle lamp that allow for more secure installation of the connector on a film included in the vehicle lamp.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, a vehicle lamp may include a film; a first injection molding part formed by mounting the film between a first mold and a second mold, which is disposed to face the first mold, and injecting molten resin from the first mold onto one side of the film; a second injection molding part formed by positioning a third mold, which is disposed to be opposite to the second mold, to face the first mold and injecting molten resin between the other side of the film and the third mold; and a light-blocking part formed by positioning the third mold to face a fourth mold and injecting molten resin from the fourth mold onto the second injection molding part.

According to another aspect of the present disclosure, a method of manufacturing a vehicle lamp may include a first step of mounting a film between a first mold and a second mold, which is disposed to face the first mold; a second step of injecting molten resin from the first mold onto a first side of the film to form a first injection molding part; a third step of positioning a third mold, which is disposed on an opposite side of the second mold, to face the first mold, a fourth step of injecting molten resin between a second side of the film and the third mold to form a second injection molding part; a fifth step of positioning the third mold to face a fourth mold; and a sixth step of injecting molten resin from the fourth mold onto the second injection molding part a light-blocking part.

The film may include a base layer, a light-blocking pattern disposed on the base layer, and a heating wire pattern disposed on the base layer.

The first injection molding part may correspond to a light-guide plate, and the second injection molding part may correspond to an outer lens.

The light-blocking part may be formed to cover at least part of an outer edge area of the film.

According to another aspect of the present disclosure, a vehicle lamp may include a film including a heating wire pattern and a light-blocking pattern; a light-guide plate formed at a rear of the film along a propagation direction of light; an outer lens formed at a front of the film along the propagation direction of the light; and a light-blocking part formed to overlap with the outer lens and an edge area of the film.

The light-guide plate may be disposed to contact the film and the light-blocking part, the outer lens may be disposed to contact the film and the light-blocking part, and the light-blocking part may be disposed to overlap at least partially with the outer lens, relative to the film.

According to another aspect of the present disclosure, an apparatus for manufacturing a vehicle lamp may include a first mold and a second mold configured to face each other for injection molding a first injection molding part on a first side of a film; a third mold configured to face the first mold for injection molding a second injection molding part on a second side of the film; a fourth mold configured to face the third mold for injection molding a light blocking part, wherein the second mold and the third mold are provided on opposites sides of a rotating table such that one of the second mold or the third mold faces the first mold while the other of the second mold or the third mold faces the fourth mold. The first injection molding part may correspond to a light-guide plate, and the second injection molding part may correspond to an outer lens. The first mold may be provided on a fixed table, and the fourth mold may be provided on a transfer table configured to be translated toward the fixed table with the rotating table interposed therebetween.

According to another aspect of the present disclosure, a vehicle lamp includes: a film; and a connector having a housing disposed on a first side of the film, a metal plate disposed on a second side of the film, and a terminal coupled to sequentially penetrate through the housing, the film, and the metal plate. An end of the terminal that penetrate through the metal plate may be welded to the metal plate.

The film may include a heating wire pattern disposed on a first surface of the film that faces the housing or on a second surface of the film that faces the metal plate.

The terminal may include a connection part surrounded by the housing and provided to expose the terminal for an electrical connection, a penetration part disposed to extend from the connection part to penetrate through the film and the housing, and a head part disposed at a tip of the penetration part and configured to be welded to the metal plate.

The terminal may include a support part that radially protrudes from an outer circumferential surface of the penetration part to support a side opposite to the connection part relative to the housing.

The terminal may include one or more interference patterns that protrude radially from an area where the penetration part contacts the inside of the housing.

The vehicle lamp may further include a light-guide plate insert-molded (e.g., injection-molded) on the first side of the film in a lateral direction of the housing; and an outer lens insert-molded (e.g., injection-molded) on the second side of the film.

The housing may include a concave or convex pattern formed on its side in contact with the light-guide plate, and the light-guide plate may include a corresponding convex or concave pattern formed to correspond to the concave or convex pattern of the housing.

The connector may include at least two connection parts spaced apart from each other, and a partition wall disposed between the at least two connection parts inside the housing.

According to another aspect of the present disclosure, a method of manufacturing a connector for a vehicle lamp may include a seventh step of disposing a housing on a first side of a film; an eighth step of disposing a metal plate on a second side of the film at a position that corresponds to the housing; and a ninth step of coupling a terminal such that the terminal sequentially penetrates through the housing, the film, and the metal plate.

The method may further include a tenth step of welding an end of the terminal that penetrates through the metal plate to the metal plate.

The method may further include an eleventh step of providing at least two core pins and coupling a support mold such that as the core pins are inserted into the housing, the core pins abut an inner bottom surface of the housing.

The method may further include a twelfth step of molding a light-guide plate in a lateral direction of the housing on the first side of the film.

The method may further include a thirteenth step of molding an outer lens to cover at least the metal plate on the second side of the film.

The method may further include a fourteenth step of removing the support mold along with the core pins after said thirteenth step of molding the outer lens is completed.

In said eleventh step of coupling the support mold, the support mold may be coupled such that the core pins may be disposed parallel to the terminal positioned in a connection area formed inside the housing.

According to the aforementioned and other embodiments of the present disclosure, the following benefits can be provided.

First, by rotating a rotating table equipped with molds of different shapes on both sides, different configurations can be injection-molded in one manufacturing process.

Second, since the guide pins or guide blocks corresponding to the mounting area of a film are provided, the film can be more precisely mounted on the table.

Third, when injection molding is performed around the connector mounted on the film, deformation of the housing due to injection pressure and temperature can be prevented or minimized.

Fourth, since the inside of the housing is supported by core pins provided inside the support mold, deformation of the housing can be prevented or minimized during the injection process.

Fifth, since the terminals are coupled to penetrate through the housing, the film, and the metal plates, and the head parts of the terminals and the metal plates are welded, the connector can be more firmly fixed on the thin film.

It should be noted that the effects of the present disclosure are not limited to those described above, and other effects of the present disclosure will be apparent from the following description.

### BRIEF DESCRIPTION OF THE DRAWINGS

The detailed description of the exemplary embodiments of the present disclosure described below, as well as the summary described above, will be better understood when read in conjunction with the accompanying drawings. The drawings illustrate exemplary embodiments of the present disclosure for illustrative purposes. It should be understood that the present disclosure is not limited to the exact arrangements and means shown.

FIG. 1 is a reference diagram illustrating a vehicle lamp according to an embodiment of the present disclosure.

FIG. 2 is an enlarged cross-sectional view illustrating area A of the vehicle lamp of FIG. 1.

FIG. 3A is a perspective view illustrating grippers that hold a film according to an embodiment of the present disclosure.

FIG. 3B is a perspective view illustrating a guide block that sets the proper position of the film according to an embodiment of the present disclosure.

FIG. 3C is a reference diagram illustrating the operating state of the guide block of FIG. 3B.

FIG. 4 is a plan view illustrating the state where the grippers of FIG. 3A fix the film.

FIG. 5 is a perspective view illustrating the state where the film of FIG. 4, with a light-guide plate and an outer lens molded thereon, is flipped over.

FIGS. 6A and 6B are reference diagrams illustrating the surroundings of a flow mark area of the film of FIG. 5.

FIGS. 7A through 7F are reference diagrams illustrating a manufacturing apparatus for a vehicle lamp according to an embodiment of the present disclosure.

FIG. 8 is a flowchart illustrating a method of manufacturing the vehicle lamp of FIGS. 7A-7F.

FIG. 9 is a plan view illustrating a vehicle lamp according to another embodiment of the present disclosure.

FIG. 10 is an enlarged plan view illustrating the connector of the vehicle lamp of FIG. 9.

FIG. 11 is a cross-sectional view illustrating the A-A section of the vehicle lamp of FIG. 9.

FIG. 12 is a cross-sectional view illustrating the B-B section of the vehicle lamp of FIG. 10.

FIG. 13 is a cross-sectional view illustrating the C-C section of the vehicle lamp of FIG. 10.

FIG. 14 is a cross-sectional view illustrating the vehicle lamp of FIG. 11.

FIGS. 15A and 15B are enlarged reference diagrams illustrating the surroundings of the terminal of the vehicle lamp of FIG. 14.

FIG. 16 is a flowchart illustrating a method of manufacturing the connector of a vehicle lamp according to an embodiment of the present disclosure.

### DETAILED DESCRIPTION

Exemplary embodiments of the present disclosure will hereinafter be described in detail with reference to the accompanying drawings. The advantages and features of the present disclosure, and methods for achieving them, will become apparent by referring to the embodiments described in detail below in conjunction with the accompanying drawings. However, it should be understood that the present disclosure is not limited to the embodiments disclosed below but can be implemented in various different forms, and the embodiments are provided to make the present disclosure complete and to fully inform those skilled in the art of the scope of the disclosure. The disclosure is defined only by the scope of the claims. Throughout the specification, the same reference numerals refer to the same components.

The present disclosure can undergo various modifications and have various embodiments, and specific embodiments will be illustrated and described in the drawings.

However, this is not intended to limit the present disclosure to such specific embodiments, and it should be understood to include all modifications, equivalents, and alternatives within the spirit and scope of the disclosure.

Terms including ordinal numbers such as first, second, etc., may be used to describe various components, but these components are not limited by these terms. These terms are used only to distinguish one component from another. For example, a second component can be named a first component without departing from the scope of the disclosure, and similarly, a first component can be named a second component.

The term “and/or” includes any combination of one or more of the associated listed items or any of the listed items individually.

When a component is said to be “connected to” or “coupled to” another component, it may be directly connected or coupled to the other component, or intervening components may be present. Conversely, when a component is said to be “directly connected to” or “directly coupled to” another component, there are no intervening components.

The terms used in this application are for the purpose of describing particular embodiments only and are not intended to limit the disclosure.

Unless the context clearly indicates otherwise, the singular forms include the plural forms as well.

In this application, the terms “comprising” or “including” are intended to specify the presence of stated features, numbers, steps, operations, elements, components, or combinations thereof, but do not preclude the presence or addition of one or more other features, numbers, steps, operations, elements, components, or combinations thereof.

Embodiments will hereinafter be described with reference to the accompanying drawings, wherein the same or corresponding components, regardless of the drawing numbers, are assigned the same reference numbers, and redundant descriptions will be omitted.

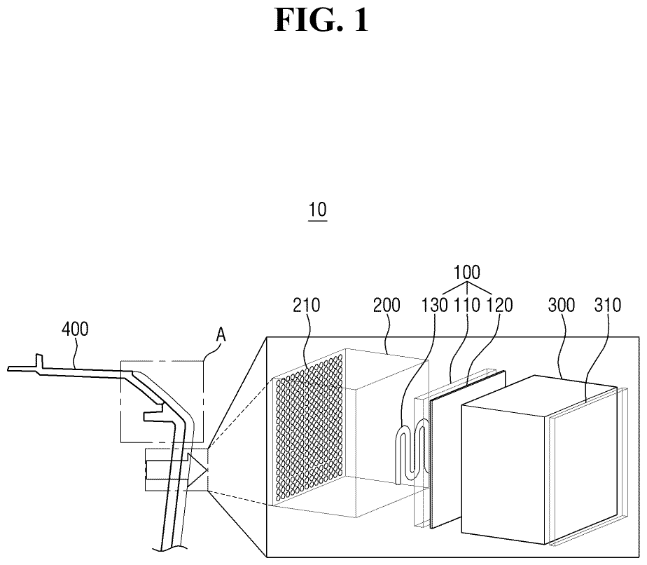

FIG. 1 is a reference diagram illustrating a vehicle lamp according to an embodiment of the present disclosure. Referring to FIG. 1, a vehicle lamp 10 may include a film 100, a light-guide plate 200, an outer lens 300, and a light-blocking part 400.

The film 100 may include a base layer 110, a light-blocking pattern 120, and a heating wire pattern 130.

The base layer 110 may be composed of a thin film formed of a transparent material. For example, the base layer 110 may be formed of a polycarbonate (PC) material.

On a first side of the base layer 110, the light-blocking pattern 120 may be provided to prevent light supplied from a light source from passing through at least some area. For example, the light-blocking pattern 120 may function to separate the area through which light passes into multiple areas or to partially limit the area through which light passes.

On a second side of the base layer 110, the heating wire pattern 130 may be provided. The heating wire pattern 130 may be formed on the second side of the base layer 110. Alternatively, a plurality of base layers 110 may be provided, and the heating wire pattern 130 may be interposed between the plurality of base layers 110. The heating wire pattern 130 may be formed of a copper (Cu) wire. For example, the heating wire pattern 130 may be formed in a zigzag pattern having a set distance between the reciprocal lines.

FIG. 1 illustrates that the light-blocking pattern 120 is arranged in the direction of the outer lens 300 from the base layer 110, and the heating wire pattern 130 is arranged in the direction of the light-guide plate 200 from the base layer 110, but the present disclosure is not limited thereto. Alternatively, the light-blocking pattern 120 and the heating wire pattern 130 may each be arranged on opposite sides of the base layer. In some other embodiments, the light-blocking pattern 120 and the heating wire pattern 130 may both be arranged on one side (the first side or the second side) of the base layer 110. Additionally, the light-guide plate 200 may correspond to a first injection molding part, and the outer lens 300 may correspond to a second injection molding part.

The light-guide plate 200 may function to guide light incident from the light source to be uniformly distributed in the direction where light is output. For example, a matrix of dot pattern 210 may be formed on the surface of the light-guide plate 200 where the light enters to more uniformly distribute the amount of light across all areas. For example, the dot pattern 210 may be formed in a conical shape inside the light-guide plate 200, but the shape of the dot pattern 210 is not particularly limited.

Additionally, the outer lens 300 may function to emit light that is incident through the light-guide plate 200 to the outside.

The light-blocking part 400 may prevent light from being emitted from at least one side of the outer lens 300. The light-blocking part 400 may also prevent light from being emitted to another side neighboring the one side of the outer lens 300. The light-blocking part 400 may be formed of a black or dark-colored material, or may be formed of an opaque material. The light-blocking function of the light-blocking part 400 may also be implemented through coating or deposition. The area where the light-blocking part 400 is formed inside the outer lens 300 may prevent the light emitted from the light source from directly passing through. However, the light that has passed through the light-guide plate 200 may be refracted as it reaches the outer lens 300, and may be indirectly emitted from the outside of the outer lens 300 where the light-blocking part 400 is arranged.

Referring to FIG. 1, a hard coating layer 310 may be disposed outside the outer lens 300. The hard coating layer 310 may function to protect the outer lens 300 and simultaneously minimize discoloration (e.g., yellowing or whitening) of the outer lens 300.

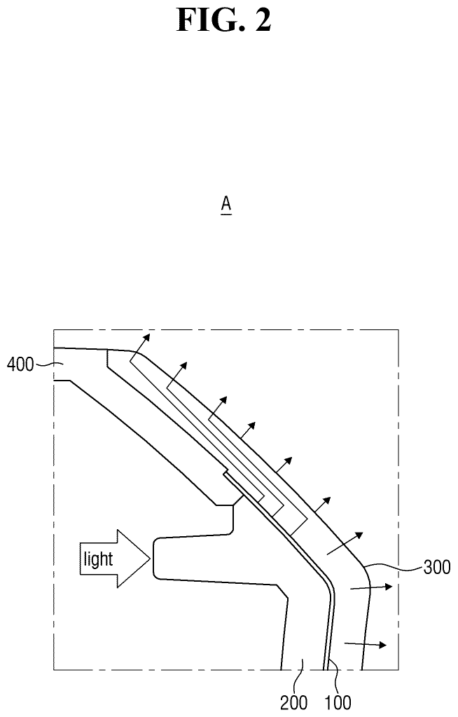

FIG. 2 is an enlarged cross-sectional view illustrating area A of the vehicle lamp of FIG. 1. Referring to FIG. 2, the outer lens 300 may be disposed on the outer side of the film 100, and the light-guide plate 200 and at least a portion of the light-blocking part 400 may be disposed on the inner side of the film 100. The light provided from the light source may pass through the film 100 and subsequently be emitted to the outside through the outer lens 300. In the area where the light-guide plate 200 and the light-blocking part 400 abut each other behind the outer lens 300, part of the edge area of the film 100 may be disposed to overlap not only with the light-guide plate 200 but also with the light-blocking part 400.

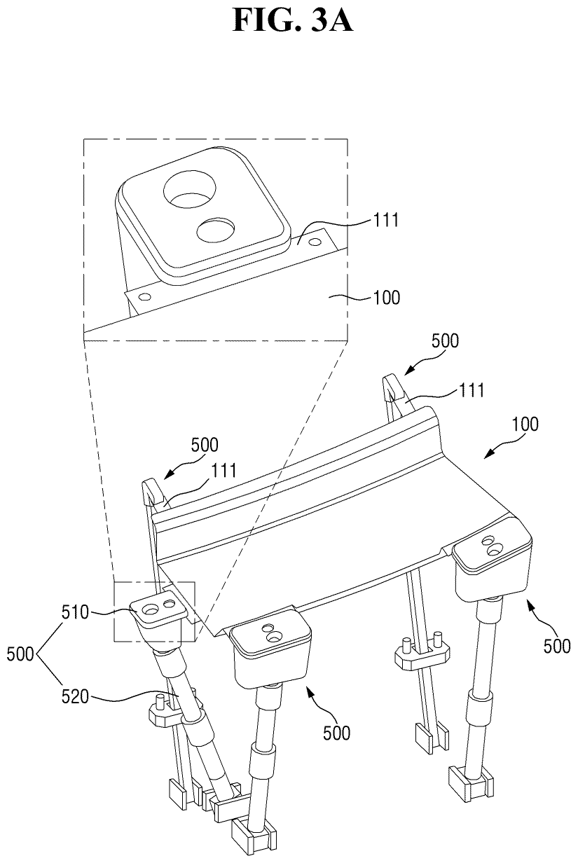

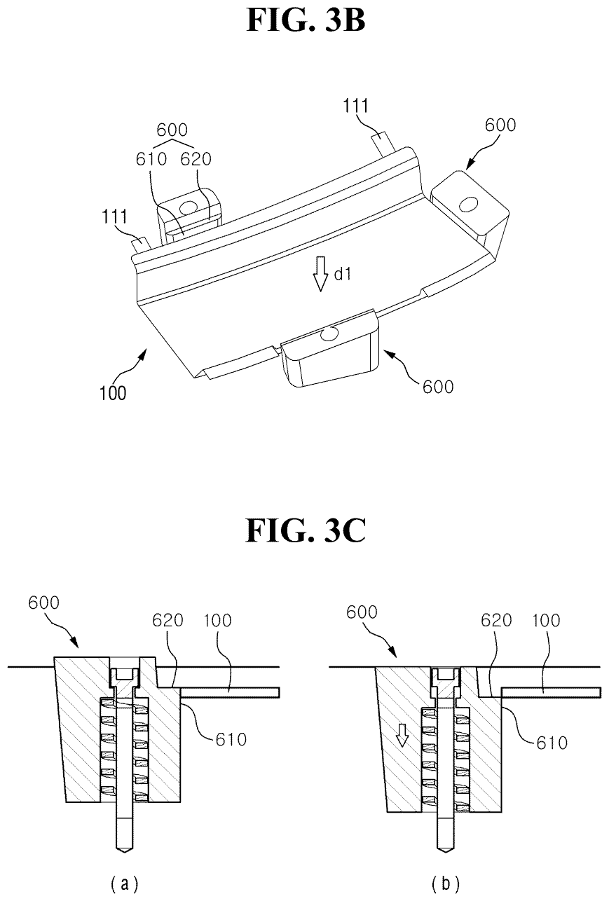

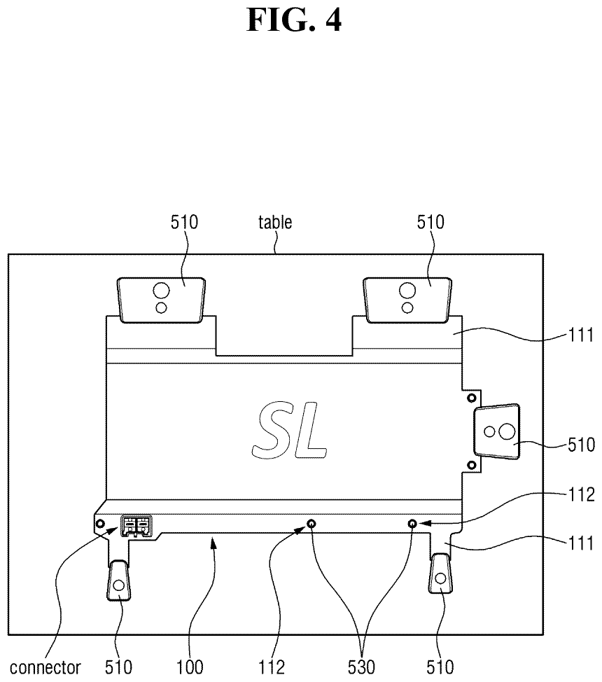

FIG. 3A is a perspective view illustrating grippers that hold the film according to an embodiment of the present disclosure, FIG. 3B is a perspective view illustrating a guide block that sets the precise position of the film according to an embodiment of the present disclosure, and FIG. 3C is a reference diagram illustrating the operating state of the guide block of FIG. 3B. FIG. 4 is a plan view illustrating the state where the grippers of FIG. 3A fix the film.

Referring to FIGS. 3A-3C and 4, when the film 100 is fixed on a table (or mold), which will be described later, gripping portions 111, which are provided at the edge area of the film 100, may be pressed and fixed by grippers 500. A plurality of gripping portions 111 may be provided at the edge area of the film 100, and a plurality of grippers 500 may be provided to respectively correspond to the plurality of gripping portions 111. The grippers 500 may be operated through the same sequence control.

Each of the plurality of grippers 500 may include a head member 510 and a lifting member 520.

As illustrated in FIGS. 3A through 3C, the head member 510 may be disposed to be selectively in contact with or spaced apart from the corresponding gripping portion 111 of the film 100. In other words, when the head member 510 contacts the corresponding gripping portion 111, it may press and fix the film 100 on the table, and when the head member 510 is spaced apart from the corresponding gripping portion 111, the film 100 may become releasable from the table.

Additionally, the lifting member 520 may be in the form of a cylinder (e.g., a hydraulic cylinder) that can be increased or decreased in length. For example, the lifting member 520 may be configured such that it moves horizontally within a set range while it is being moved vertically. Thus, when being ascended, the lifting member 520 may also move outwardly from the edge area of the film 100. Conversely, when being descended, the lifting member 520 may move inwardly to press and fix the upper part of the corresponding gripping portion 111 of the film 100.

When the film 100 is fixed on the table by the grippers 500, deformation or lifting of the film 100 can be prevented during an insert molding process.

One or more guide pins 530 may be provided on the table to provide aid in mounting the film 100 in a set position. Correspondingly, the film 100 may include guide holes 112 into which the guide pins 530 may be inserted. The guide pins 530 and the guide holes 112 may be formed to correspond to each other in terms of position and number.

Additionally, referring to FIGS. 3B and 3C, a guide block 600 configured to be disposed at the edge area of the film 100 to set the correct position of the film 100 may be further provided around the table. The guide block 600 may preferably be disposed in a position that does not interfere with the grippers 500. A plurality of guide blocks 600 may be provided around the edge area of the film 100 to be spaced apart from one another. Additionally, the guide block 600 may be disposed to be elastically movable along the mounting direction of the film 100.

The guide block 600 may include a contact surface 610, which faces the film 100, and a step 620, which is recessed from the contact surface 610 to be disposed at the same height as the film 100 when the guide block 600 is pressed along the mounting direction of the film 100.

When the guide block 600 is protruded from the table, the contact surface 610 may be disposed to abut the edge area of the film 100. In this case, since the contact surface 610 supports the film 100, the mounted state of the film 100 on the table can be maintained after seating the film 100.

Additionally, when the guide block 600 is elastically pressed into the table against a spring 630, the contact surface 610 may dislodge the edge area of the film 100, and the upper surface of the step 620 may be disposed at the same height as the lower surface of the film 100.

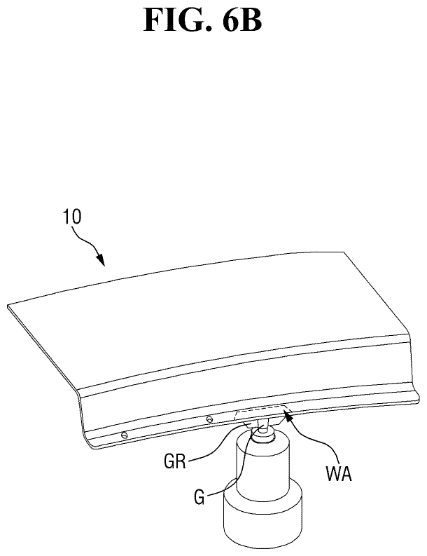

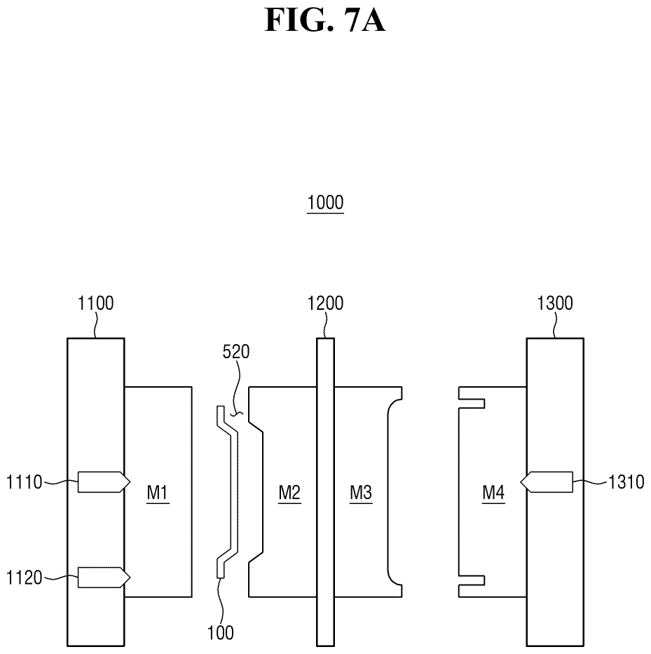

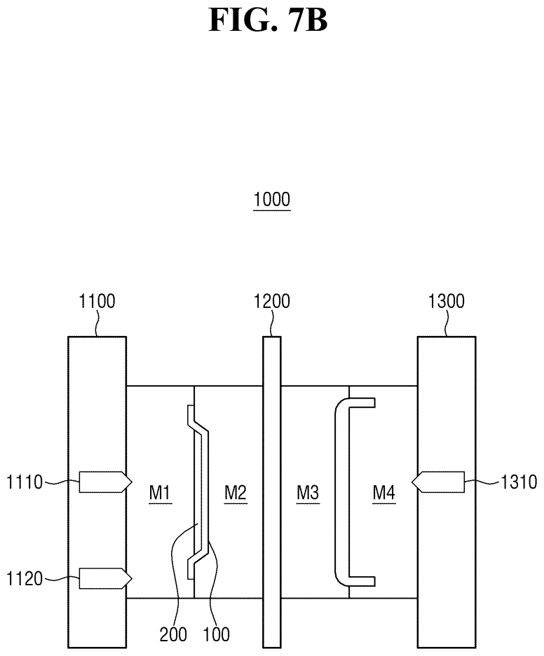

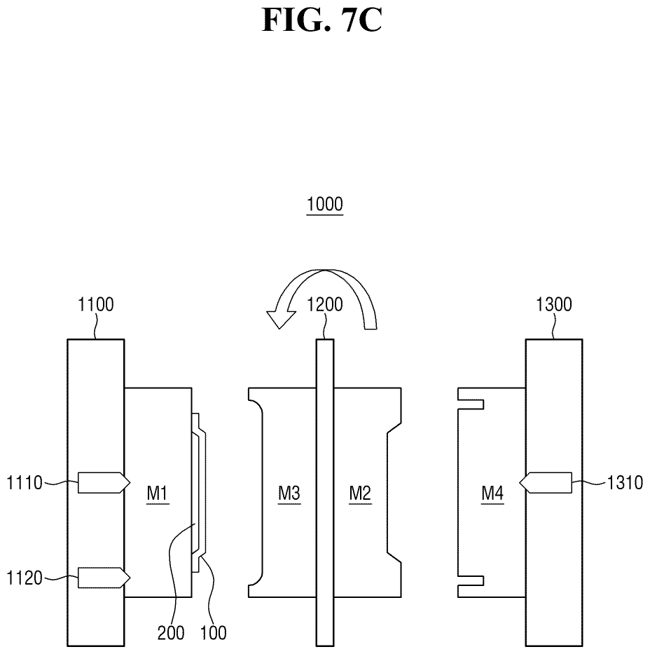

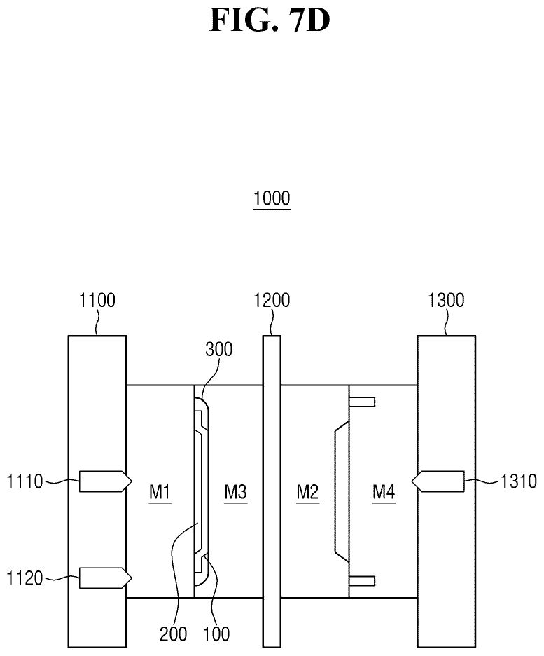

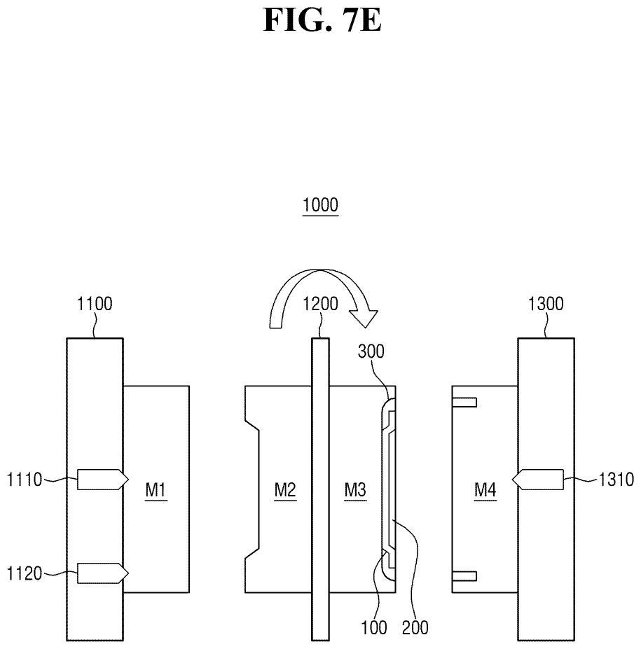

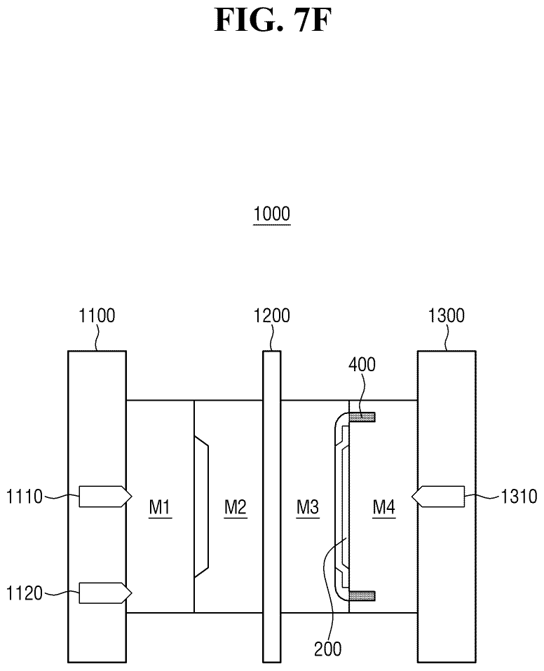

The table, the grippers 500, and the guide block 600 may be components included in a manufacturing apparatus 1000 (see FIGS. 7A-7F) for a vehicle lamp. A connector shown in FIG. 4 will be described later.

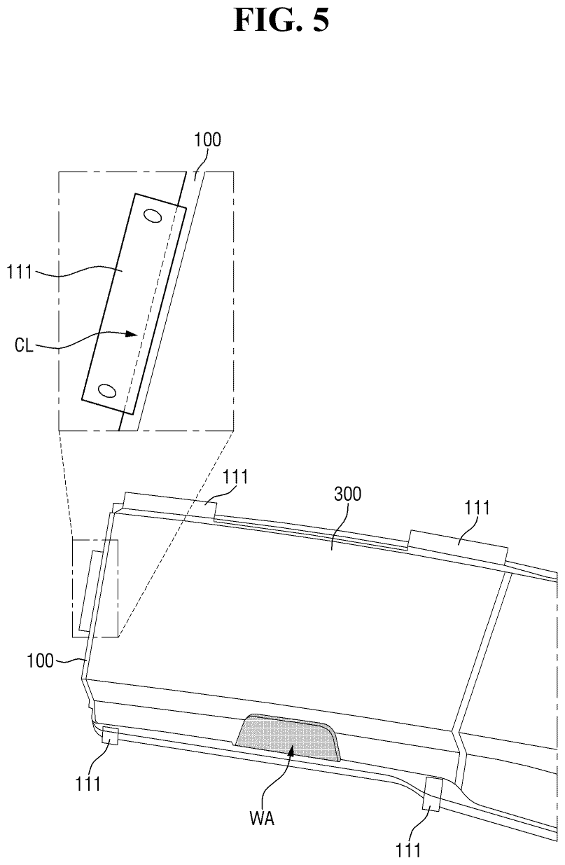

FIG. 5 is a perspective view illustrating the state in which the light-guide plate and the outer lens are molded on the film of FIG. 4. Referring to FIG. 5, in the state where the molding of the light-guide plate 200 and the outer lens 300 on the film 100 is completed, each of the gripping portions 111 may be partially or entirely cut off. For example, each of the gripping portions 111 may be removed through ultrasonic cutting along a cutting line CL.

During the insertion and molding of the film 100 on the table, flow mark defects may occur in some places due to the high flow rate of the molten resin. Specifically, due to the high flow velocity of the molten resin, the black-colored light-blocking pattern 120 of FIG. 1 may be washed off, and flow mark defects may occur in a flow mark area WA. Therefore, the light-blocking part 400 may be injection-molded such that the flow mark area WA may be covered not to be visible from the outside.

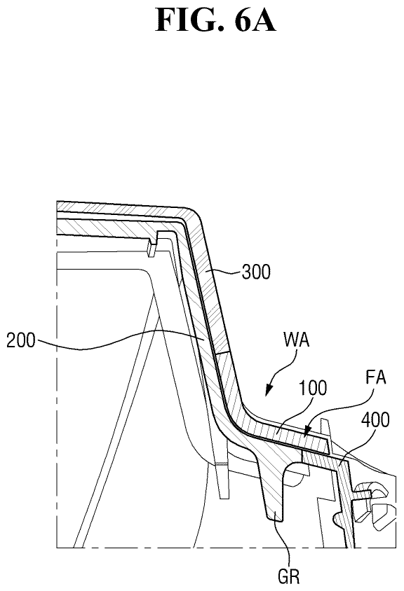

FIGS. 6A and 6B are reference diagrams illustrating the surroundings of the flow mark area of the film of FIG. 5. In particular, FIG. 6A is a cross-sectional view illustrating the surroundings of the flow mark area, and FIG. 6B is a perspective view illustrating a gate rib.

A gate rib GR may be additionally provided around the flow mark area WA. A molten resin may be injected into the gate rib GR, which may reduce the injection pressure and speed. Therefore, by injecting the resin through the gate rib GR, the flow mark area WA may be minimized. The gate rib GR may be disposed adjacent to a first injection part 1110 (see FIGS. 7A-7F) that molds the light-guide plate 200. The first injection part 1110 will be described later.

The gate rib GR may be provided inside the first injection part 1110, and as the molten resin is injected through the gate rib GR, the light-guide plate 200 may be molded. In an embodiment where the outer lens 300 is molded first without molding the light-guide plate 200 on the film 100, the gate rib GR may also be provided at the part where the molten resin for molding the outer lens 300 is injected.

As the resin is first injected through a gate G, disposed in the center area of the gate rib GR, and the molten resin fills the inside space of the gate rib GR, a flange area FA formed on the side of the film 100 may be pressed. In other words, the molten resin injected through the gate G and the gate rib GR may press the film 100 while being supplied, and as the area for supplying the resin through the gate G and the gate rib GR widens, the supply pressure and speed of the resin decrease, effectively minimizing the flow mark area WA.

FIGS. 7A-7F are reference diagrams illustrating a manufacturing apparatus for a vehicle lamp according to an embodiment of the present disclosure. Referring to FIGS. 7A-7F, the manufacturing apparatus 1000 may include a fixed table 1100, a rotating table 1200, and a transfer table 1300.

The fixed table 1100 may include a first mold M1. Additionally, the rotating table 1200 may include a second mold M2 and a third mold M3. The transfer table 1300 may include a fourth mold M4.

The fixed table 1100 may include a first injection part 1110 and a second injection part 1120 for injecting molten resin toward the first mold M1. The first injection part 1110 may supply a molten resin necessary for molding the light-guide plate 200. The second injection part 1120 may supply a molten resin necessary for molding the outer lens 300. The first injection part 1110 or the second injection part 1120 may inject resin through the gate rib GR.

Additionally, the second mold M2 and the third mold M3 may be disposed on both sides of the rotating table 1200. The second mold M2 and the third mold M3 may be selectively rotated to face the first mold M1 or the fourth mold M4.

The rotating table 1200 may move in the direction of the fixed table 1100. For example, the fixed table 1100 may remain stationary, and as the rotating table 1200 moves toward the fixed table 1100, the first mold M1 and the second mold M2 may face each other, or the first mold M1 and the third mold M3 may face each other.

The grippers 500, which press and fix the gripping portions 110 at the edge area of the film 100, may be provided in the second mold M2 or the third mold M3.

The transfer table 1300 may move in the direction of either the rotating table 1200 or the fixed table 1100. For example, the transfer table 1300 may move to be in close contact with the rotating table 1200, or with both the rotating table 1200 and the fixed table 1100.

The transfer table 1300 may include a third injection part 1310 for injecting molten resin toward the fourth mold M4. The third injection part 1310 may supply a molten resin necessary for molding the light-blocking part 400.

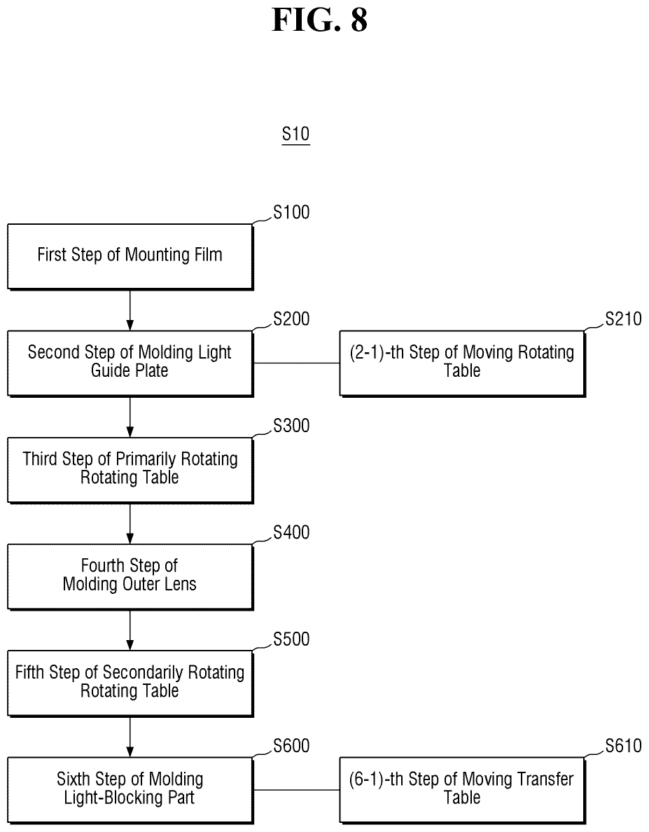

FIG. 8 is a flowchart illustrating a method S10 of manufacturing the vehicle lamp of FIGS. 7A-7F. Referring to FIGS. 7A-7F and 8 together, the method S10 may include a first step S100 of mounting the film 100 between the first mold M1 and the second mold M2 (FIG. 7A), a second step S200 of molding the light-guide plate 200 on a first side of the film 100 by injecting molten resin between the film 100 and the first mold M1 (FIG. 7B), a third step S300 of rotating the rotating table 1200 so that the third mold M3 faces the first mold M1 with the light-guide plate 200 and the film 100 attached to the first mold M1 (FIG. 7C), a fourth step S400 of molding the outer lens 300 by injecting molten resin between a second side of the film 100 and the third mold M3 (FIG. 7D), a fifth step S500 of rotating the rotating table 1200 so that the fourth mold M4 faces the third mold M3 with the outer lens 300 attached to the third mold M3 (FIG. 7E), and a sixth step S600 of molding the light-blocking part 400 by injecting molten resin toward the outer lens 300 from the fourth mold M4 (FIG. 7F).

In the first step S100, the film 100 may be fixed by being inserted into the guide pins 530 during the mounting of the film 100 onto the second mold M2. Additionally, in the first step S100, the film 100 may be mounted on the second mold M2, and the grippers 500 may press and fix the film 100.

The second step S200 may include a sub-step S210 of moving the rotating table 1200 to be in close contact with the fixed table 1100 or moving the transfer table 1300 along with the rotating table 1200 to be in close contact with the fixed table 1100. In the second step S200, after the completion of the sub-step S210, molten resin may be injected through the first injection part 1110 to mold the light-guide plate 200. After the second step S200 is completed, the first and second molds M1 and M2 may be separated. In this case, the film 100 and the molded light-guide plate 200 may be positioned on the first mold M1.

In the third step S300, the primary rotation of the rotating table 1200 may be performed after the second mold M2 is separated from the first mold M1, with the film 100 and the light-guide plate 200 positioned on the first mold M1. When the primary rotation of the rotating table 1200 is performed in the third step S300, the rotating table 1200 may be rotated so that the third mold M3 faces the first mold M1.

After the third step S300 is completed, the fourth step S400 may be performed by bringing the third mold M3 into close contact with the first mold M1. In the fourth step S400, the outer lens 300 may be molded by supplying molten resin between the other side of the film 100 and the third mold M3 through the second injection part 1120. For example, the first injection part 1110 may supply resin from the central area of the first mold M1, and the second injection part 1120 may be disposed to supply resin from the outer area compared to the first injection part 1110. After the fourth step S400 is completed, the first mold M1 and the third mold M3 may be separated. In this case, the film 100, the molded light-guide plate 200, and the molded outer lens 300 may be positioned on the third mold M3.

In the fifth step S500, the secondary rotation of the rotating table 1200 may be performed so that the first mold M1 and the third mold M3 may face the second mold M2 and the fourth mold M4, respectively. As the rotating table 1200 rotates again in the fifth step S500, the area of the light-guide plate 200 may be disposed to be in close contact with the fourth mold M4 at the beginning of the sixth step S600 since the outer lens 300 is attached to the third mold M3.

The sixth step S600 may include a sub-step S610 of moving the transfer table 1300 to be in close contact with the rotating table 1200 or with both the rotating table 1200 and the fixed table 1100. After the sub-step S610 is completed, the light-blocking part 400 may be molded by injecting molten resin through the third injection part 1310 into the area adjacent to the outer lens 300 or the area adjacent to both the outer lens 300 and the light-guide plate 200.

Through the method S10, a vehicle lamp may be manufactured by rotating the rotating table 1200 equipped with different molds twice on a single table, thereby eliminating the need to transfer the product to another table and effectively reducing the process time. Additionally, since no product transfer between tables is needed, processes such as preheating during product transfer can be omitted.

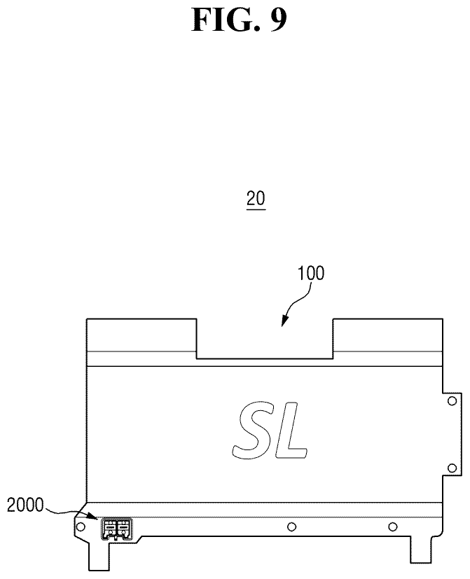

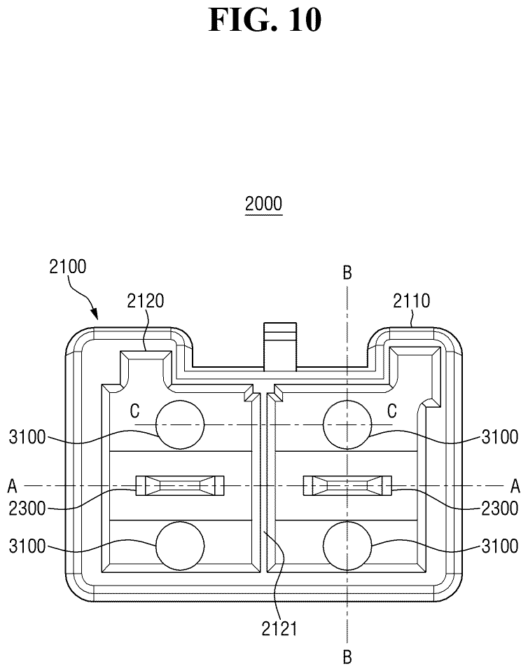

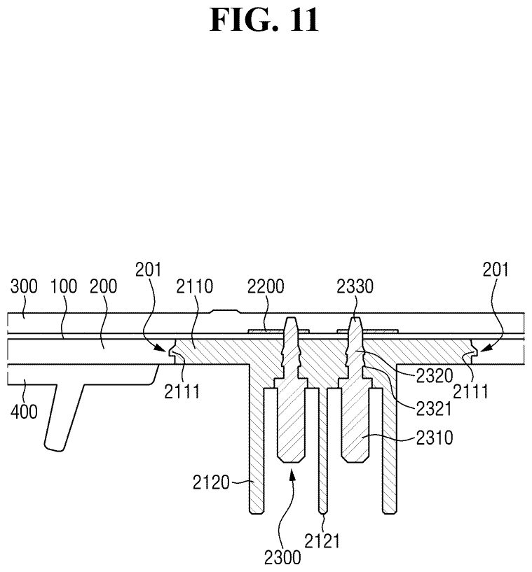

FIG. 9 is a plan view illustrating a vehicle lamp according to an embodiment of the present disclosure, FIG. 10 is an enlarged plan view illustrating the connector of the vehicle lamp of FIG. 9, and FIG. 11 is a cross-sectional view illustrating the A-A section of the vehicle lamp of FIG. 9. Referring to FIGS. 9 through 11, a vehicle lamp 20 may include a film 100 and a connector 2000. Here, since the film 100 has been described above, the description thereof will be omitted.

The connector 2000 may be disposed on the first side of the film 100 to be connected to a power supply line, which supplies power to a heating wire pattern 130 (refer back to FIG. 1). The connector 2000 may include a housing 2100, metal plates 2200, and terminals 2300.

The housing 2100 may be disposed on the first side of the film 100, and the metal plates 2200 may be disposed on the second side of the film 100. The terminals 2300 may be inserted sequentially through the housing 2100, the film 100, and the metal plates 2200, thereby fixing the connector 2000 on the film 100.

The ends of the terminals 2300 that penetrate through the metal plates 2200 may be fixed by welding on the outside of the metal plate 2200. The metal plates 2200 may be configured to be supported on the second side of the film 100 to face the housing 2100 from the film 100. Therefore, the housing 2100 and the metal plates 2200 may be securely bonded together through the terminals 2300 on a thin film, maintaining a stable connection.

With the connector 2000 mounted on the film 100, the light-guide plate 200 may be injection-molded on the first side of the film 100, and the outer lens 300 may be injection-molded on the second side of the film 100. However, there may be a concern that the housing 2100 or the terminal 2300 may be deformed from its set position or direction due to the injection pressure and temperature.

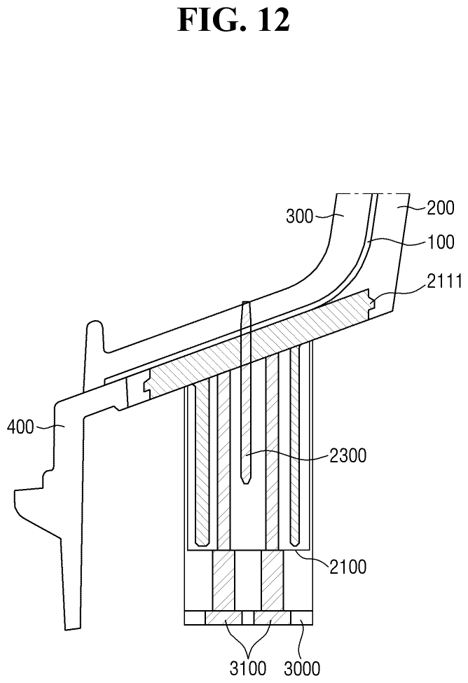

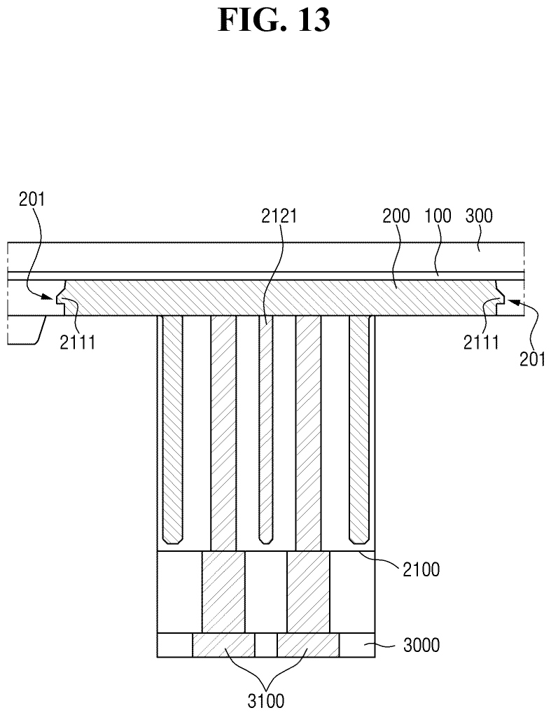

FIG. 12 is a cross-sectional view illustrating the B-B section of the vehicle lamp of FIG. 10, and FIG. 13 is a cross-sectional view illustrating the C-C section of the vehicle lamp of FIG. 10.

To prevent deformation of the housing 2100 or the terminal 2300, core pins 3100 may be inserted into the housing 2100 during injection molding. For example, the core pins 3100 may be inserted into the housing 2100 to be in close contact with the inner bottom surface of the housing 2100, with at least two core pins 3100 inserted.

The core pins 3100 may be provided on a support mold 3000 that is coupled to the housing 2100. For example, at least two core pins 3100 may preferably be provided. When two core pins 3100 are disposed side by side, they may be inserted along whichever of the left-right and top-bottom directions of the housing 2100 is longer. For example, as illustrated in FIG. 10, four core pins 3100 may be provided in the up-down and left-right directions. However, the number of core pins 3100 is not particularly limited, and the core pins 3100 may be implemented in various shapes. Additionally, the core pins 3100 may generally have a cylindrical shape with a circular cross-section. Alternatively, the core pins 3100 may have an elliptical or polygonal cross-sectional shape, and two core pins 3100 may be arranged diagonally, with varying diameters or cross-sectional areas along their length direction.

The housing 2100 may also include a contact piece 2110 that contacts the first side of the film 100 and a coupling piece 2120 that is provided outside the terminals 2300, such that another housing (e.g., a connector housing) of a power supply line may be coupled thereto.

The contact piece 2110 may be provided with a concave or convex pattern along the edge area where the light-guide plate 200 is injection-molded. When the light-guide plate 200 is injection-molded, a convex or concave pattern may be formed in the light-guide plate 200 to correspond to the concave or convex pattern of the contact piece 2110. For example, convex portions 2111 may be provided along the edge of the contact piece 2110, and corresponding concave portions 201 may be formed during the molding of the light-guide plate 200.

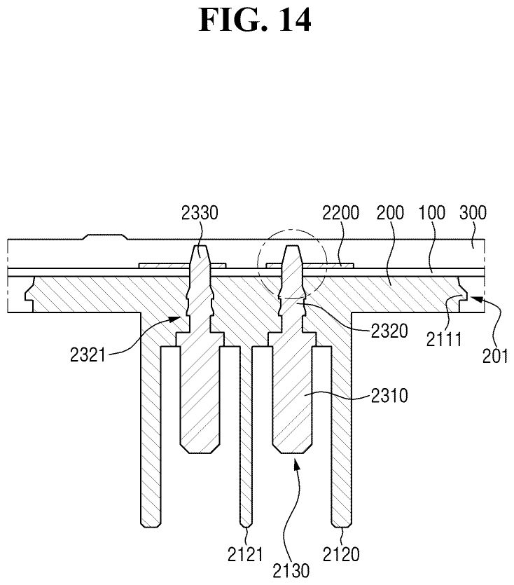

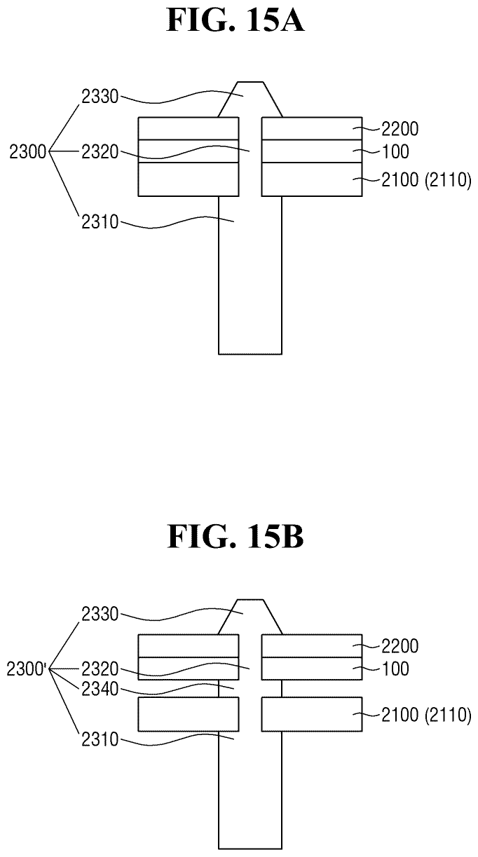

FIG. 14 is a cross-sectional view illustrating the vehicle lamp of FIG. 11, and FIGS. 15A and 15B are enlarged reference diagrams illustrating the surroundings of a terminal of the vehicle lamp of FIG. 14. Referring to FIGS. 14, 15A, and 15B, each terminal 2300 may include a connection part 2310, a penetration part 2320, and a head part 2330.

The connection part 2310 may be an area exposed inside the coupling piece 2120 of the housing 2100. Therefore, when another housing with a power supply is connected, the connection part 2310 may be electrically connected.

Additionally, the penetration part 2320 may extend from the end of the connection part 2310 and pass through the film 100 and the housing 2100. In other words, the penetration part 2320 may be disposed inside the film 100 and the housing 2100. The penetration part 2320 may include one or more interference patterns 2321 in the area where it contacts the inside of the housing 2100.

The interference patterns 2321 may function to enhance binding by increasing the contact area between the penetration part 2320 and the inside of the housing 2100. The penetration part 2320 may be integrally formed with the connection part 2310. Some area of the penetration part 2320 may be formed wider than the connection part 2310.

The head part 2330 may be disposed at the tip of the penetration part 2320 to penetrate through the corresponding metal plate 2200. For example, two terminals 2300 may be provided inside the housing 2100, or alternatively, more than two terminals 2300 may be provided. Inside the housing 2100, two connection parts 2310 may be exposed, and a partition wall 2121 may be provided to divide the space between the two connection parts 2310. The partition wall 2121 may also contribute to preventing the deformation of the housing 2100 during injection molding around the housing 2100 and the film 100.

FIG. 15A illustrates an exemplary terminal 2300, and FIG. 15B illustrates another exemplary terminal 2300′. Referring to FIG. 15A, a penetration part 2320 may be disposed between a connection part 2310 and a head part 2330 so that the housing 2100, the film 100, and the corresponding metal plate 2200 may all be in close contact around the penetration part 2320. Referring to FIG. 15B, a support part 2340 that protrudes laterally around a penetration part 2320 may be provided. The support part 2340 may be disposed to support the side opposite to the connection part 2310 relative to the housing 2100. Accordingly, the terminal 2300′ may be more firmly supported and installed on the housing 2100. Additionally, since the film 100 and the corresponding metal plate 2200 are positioned between the support part 2340 and the head part 2330, the film 100 and the corresponding metal plate 2200 may be more firmly supported through the terminal 2300′.

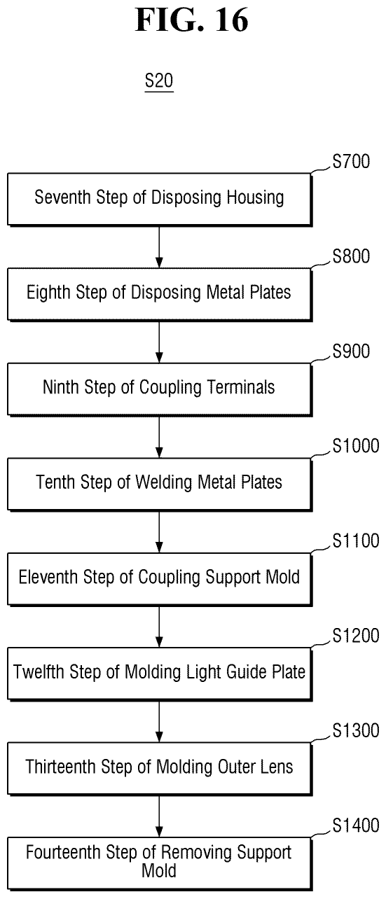

FIG. 16 is a flowchart illustrating a method S20 of manufacturing a connector for a vehicle lamp according to an embodiment of the present disclosure. Referring to FIG. 16, the method S20 may include a seventh step S700 of disposing the housing 2100 on the first side of the film 100, an eighth step S800 of disposing the metal plates 2200 on the second side of the film 100 to correspond to the position of the housing 2100, and a ninth step S900 of assembling the terminals 2300 to sequentially penetrate through the housing 2100, the film 100, and the metal plates 2200. The steps of the method S20 may overlap with the steps of the method S10, differing only in the sequence.

In other words, in the method S20, the housing 2100 may be disposed on the first side of the film 100, the metal plates 2200 may be disposed on the second side of the film 100, and the terminals 2300 may be coupled to the housing 2100, the film 100, and the metal plates 2200 by integrally penetrating them.

As described above, the film 100 may be provided with a heating wire pattern 130 on one of its surfaces that face the housing 2100 and the metal plates 2200. The position of the heating wire pattern 130 may be selectively changed. Alternatively, the film 100 may be provided with the light-blocking pattern 120. The light-blocking pattern 120 may be disposed on the other surface of the film 100 than the heating wire pattern 130, or between the film 100 and the heating wire pattern 130.

After the ninth step S900 is completed, the method S20 may further include a tenth step S1000 of welding the ends of the terminals 2300 that penetrate through the metal plate 2200 to the metal plates 2200. The tenth step S1000 may be performed by welding the head parts 2330 of the terminals 2300 and the metal plates 2200. The tenth step S10 may be optional.

The method S20 may further include an eleventh step S1100 of coupling the support mold 3000 to the housing 2100 after the tenth step S1000 is completed. In the eleventh step S1100, the support mold 3000, which is provided with at least two core pins 3100, may be coupled to the housing 2100 such that the core pins 3100 may be in close contact with the inner bottom surface of the housing 2100. In other words, since the contact piece 2110 of the housing 2100 may be deformed by heat during injection molding, the support mold 3000 may be inserted into the housing 2100 to press the contact piece 2110 from the inside through the core pins 3100, thereby minimizing or preventing deformation of the contact piece 2110. In the eleventh step S1100, the support mold 3000 may be coupled such that the core pins 3100 may be disposed parallel to the terminals 2300 positioned in a connection area 2130 formed inside the housing 2100.

The method S20 may further include a twelfth step S1200 of molding the light-guide plate 200 on the first side of the film 100 after the eleventh step S1100 is completed. In the twelfth step S1200, the light-guide plate 200 may be molded on the first side of the film 100 in the lateral direction of the housing 2100. As described above, the light-guide plate 200 may be molded to correspond to the convex portions 2111 formed on both sides of the contact piece 2110 of the housing 2100, and as a result, the concave portions 201 may be formed. Since the convex portions 2111 and the concave portions 201 have been already described above, descriptions thereof will be omitted.

The method S20 may further include a thirteenth step S1300 of molding the outer lens 300 on the second side of the film 100. Since the molding of the outer lens 300 has been described above, a description thereof will be omitted.

The method S20 may further include a fourteenth step S1400 of removing the support mold 3000 along with the core pins 3100 from the housing 2100. The fourteenth step S1400 may be included in the method S20, but the support mold 3000 and the core pins 3100 may be omitted from the completed vehicle lamp.

Therefore, by welding the head parts 2330 of the terminals 2300 on the metal plates 2200, the fixing force of the connector 2000 may be improved, and the connector 2000 may be prevented from being easily separated from the film 100.

According to the embodiments of the present disclosure, by rotating a rotating table equipped with molds of different shapes on both sides, different configurations can be injection-molded in one manufacturing process. Guide pins or guide blocks corresponding to the mounting area of a film are provided, enabling precise mounting of the film on the table. When injection molding is performed around the connector mounted on the film, deformation of the housing due to injection pressure and temperature can be prevented. Since the inside of the housing is supported by core pins provided inside the support mold, deformation of the housing can be prevented during the injection process through. Terminals are coupled to penetrate through the housing, the film, and the metal plates, and the head parts of the terminals and the metal plates are welded, allowing the connector to be firmly fixed on the thin film.

While the technical idea of the disclosure has been illustrated and described in detail with reference to specific embodiments, the present disclosure is not limited to the specific configurations and operations of these embodiments. Various modifications can be made within the scope of the invention without departing from its spirit. Therefore, such modifications should be considered encompassed within the scope of the disclosure, and the scope of the disclosure should be determined by the appended claims.

What is claimed is:

1. A vehicle lamp comprising:
a film including a heating wire pattern and a light-blocking pattern;
a light-guide plate formed at a rear side of the film with respect to a propagation direction of light emitted from the vehicle lamp;
an outer lens formed at a front side of the film with respect to the propagation direction of the light; and
a light-blocking part formed to overlap with the outer lens and an edge area of the film.

2. The vehicle lamp of claim 1, wherein the film includes a base layer, the light-blocking pattern is formed on a first side of the base layer, and the heating wire pattern is formed on a second side of the base layer.

3. The vehicle lamp of claim 1, wherein the light-blocking part is disposed to cover at least part of an outer edge area of the film.

4. The vehicle lamp of claim 1, wherein the light-guide plate is disposed to contact the film and the light-blocking part,
wherein the outer lens is disposed to contact the film and the light-blocking part, and
wherein the light-blocking part is disposed to overlap at least partially with the outer lens, relative to the film.

5. A vehicle lamp comprising:
a film; and
a connector having a housing disposed on a first side of the film, a metal plate disposed on a second side of the film, and a terminal coupled to sequentially penetrate through the housing, the film, and the metal plate,
wherein an end of the terminal that penetrates through the metal plate is welded to the metal plate.

6. The vehicle lamp of claim 5, wherein the film includes a heating wire pattern disposed on a first surface of the film that faces the housing or on a second surface of the film that faces the metal plate.

7. The vehicle lamp of claim 6, wherein the terminal comprises:
a connection part surrounded by the housing and provided to expose the terminal for an electrical connection;
a penetration part disposed to extend from the connection part to penetrate through the film and the housing; and
a head part disposed at a tip of the penetration part and configured to be welded to the metal plate.

8. The vehicle lamp of claim 7, wherein the terminal further comprises a support part that radially protrudes from an outer circumferential surface of the penetration part to support a side opposite to the connection part relative to the housing.

9. The vehicle lamp of claim 7, wherein the terminal includes one or more interference patterns that protrude radially from an area where the penetration part contacts the inside of the housing.

10. The vehicle lamp of claim 5, further comprising:
a light-guide plate that is insert-molded on the first side of the film in a lateral direction of the housing; and
an outer lens that is insert-molded on the second side of the film.

11. The vehicle lamp of claim 10, wherein the housing includes a concave or convex pattern formed on its side in contact with the light-guide plate, and
wherein the light-guide plate includes a corresponding convex or concave pattern formed to correspond to the concave or convex pattern of the housing.

12. A method of manufacturing a connector for a vehicle lamp, comprising:
disposing a housing on a first side of a film;
disposing a metal plate on a second side of the film at a position that corresponds to the housing; and
coupling a terminal such that the terminal sequentially penetrates through the housing, the film, and the metal plate.

13. The method of claim 12, further comprising:
welding an end of the terminal that penetrates through the metal plate to the metal plate.

14. The method of claim 12, further comprising:
providing at least two core pins and coupling a support mold such that as the core pins are inserted into the housing, the core pins abut an inner bottom surface of the housing.

15. The method of claim 14, further comprising:
molding a light-guide plate in a lateral direction of the housing on the first side of the film.

16. The method of claim 15, further comprising:
molding an outer lens to cover at least the metal plate on the second side of the film.

17. The method of claim 16, further comprising:
removing the support mold along with the core pins after said step of molding the outer lens is completed.

18. The method of claim 14, wherein in said step of coupling the support mole, the support mold is coupled such that the core pins are disposed parallel to the terminal positioned in a connection area formed inside the housing.
